(19) United States
(12) Patent Application Publication
(10) Pub. No.: US 2004/0036048 A1
(43) Pub. Date: Feb. 26, 2004

(54) Gaseous fuel injector

(76) Inventor: Peter Waygaard Petersen, Woodland Park, CO (US)

Correspondence Address: Ilya Zborovsky, 6 Schoolhouse Way, Dix Hills, NY, 11746, US

(21) Appl. No.: 10/223,221

(22) Filed: Aug. 20, 2002

(51) Int. Cl. F16K 31/02

(52) U.S. Cl. 251/129.15

(57) ABSTRACT

An injector has a housing, a valve element located in the housing, an armature movable in the housing, and a coupling providing coupling of the armature with the valve element and formed as ball-and-socket coupling allowing continuous alignment of the armature and the valve element relative to one another. The injector has self-energizing armature guiding elements, self-cleaning design, low-noise design, and zero air gap magnetic circuit.

### BACKGROUND OF THE INVENTION

The present invention relates to a gaseous fuel injector.

Gaseous fuel injectors are used for engine fuel management, and their applications have increased due to cost and emission advantages of these fuels. Many suppliers have tried to use existing gasoline-based fuel injectors to meet this demand, while others have converted hydraulic or other industrial valves to gaseous use. In general, these injectors have met with limited success due to several key differences between gaseous and liquid fuel injectors. These differences effectively prevent the majority of liquid fuel injector components from being successfully implemented for gaseous fuel use or industrial process metering.

Engine manufacturers desire injectors that provide rapid response and precise fuel metering per injection pulse. Furthermore, they require high durability and it is essential that the injector maintains high accuracy over its full life span. To achieve the desired performance attributes, the injector designer must incorporate features within the gaseous fuel injector that provide the proper sequence of operation and thereby accounts for the unique properties of gaseous fuels. The following discussion addresses the differences between conventional liquid and gaseous injectors in detail. For this discussion, compressed natural gas (CNG) will be used to represent the gaseous fuel, however, the reader should be aware that the issues are substantially similar for all gaseous fuels.

In throttle body and multipoint injection systems, CNG is typically injected at pressures ranging from 200 to 1000 kPa. Under these conditions, the energy density of CNG is significantly less than a liquid fuel such as gasoline. To account for the lower energy density of CNG, the fuel injector must open a valve element providing much greater flow area to inject the same amount of energy per pulse. This is accomplished by increasing the diameter of the valve element and/or by increasing the stroke of the valve. Both of these options are in direct opposition to the requirement for rapid response: if the valve element is larger, it is also typically of greater mass: hence, for an electromagnetic actuator of fixed force, response is slower. As for increasing the stroke of the valve element; again, for an electromagnetic actuator of given force, the force decreases exponentially with increasing stroke, so response is slower and typically accuracy also suffers.

In overcoming these limitations of flow area, a new set of problems is encountered. When an injector is commanded to open by the engine control module (ECM), the magnetic circuit is energized via a current control circuit. As magnetic flux increases within the injector's magnetic circuit, a force begins to build up across the working air gap. There are two forces that hold the injector closed: the spring force and a pressure force. Once the magnetic force overcomes the sum of these two forces, the valve element begins to move. Based upon the requirement for rapid response, the magnetic flux and hence force, increases rapidly. By the end of motion, the valve has been accelerated to relatively high velocity and, as CNG provides little or no damping, the valve element severely impacts the pole piece. This results in both wear of the injector leading to reduced accuracy and premature failure, and audible noise, which is a problem with earlier injectors.

To summarize, a CNG injector must provide rapid response to achieve high precision fuel metering pulse to pulse. It must provide high durability and maintain its accuracy and precision over the life of the injector. It must open a large orifice area to account for the low energy density of CNG. These goals have not been met using conventional liquid fuel injection technology and components. New injector designs must account for issues resulting from opposing performance characteristics in order to succeed in the new marketplace.

Unfortunately, these are not the only challenges facing a gaseous fuel injector. Another challenge is the fuel make-up and more importantly, contaminants. Natural gas is distributed within North America through a sophisticated pipeline system where the majority of fuel sent through the system is used for home heating and industrial uses. Most of these users can tolerate contaminants whereas the highly engineered, tightly toleranced automotive fuel systems cannot. Within the CNG market, fuel conditions vary greatly and typically gas contains numerous contaminants of both a particulate and vaporous nature. CNG is commonly a mixture of primarily methane and several other lighter hydrocarbons as well as inert gases. CNG can contain traces of hydrogen sulfide, water vapour, and residual oil from compression. Additionally, it contains particulate material such as shavings and metal oxides which are introduced through maintenance of pipeline and compression systems. Gas containing oil and water causes certain types of problems with gaseous fuel injectors. On the other hand, CNG from liquid (LCNG) can be pure methane and is absolutely dry and oil free. This type of fuel causes a different set of problems with gaseous fuel injectors.

To operate successfully with this fuel variability, an injector must have the following characteristics: The injector must incorporate a self-lubricating design such that can operate with oil-free LNG or hydrogen. However, the design of the “self lubricating features” must not inhibit free motion of the armature when oil is present in the gas. The design must be able to pass particulate matter and should be designed such that debris is flushed through the injector. Finally, the materials used in the construction of the injector must be suitable for use with mildly sour gas.

Another issue affecting gaseous fuel injectors is that of noise. As a result of the rapid response of the long stroke, gaseous injectors can be noisy. This is due to the velocity and hence impulsive loading with which the armature contacts the pole. Two approaches are currently viable for the reduction of noise: damping effects and the use of soft stops. This invention makes use of the compliance of the plastic seat, and if desired by the user, the plastic upper guide, to minimize noise.

### SUMMARY OF THE INVENTION

Accordingly, it is an object of the present invention to provide a gaseous fuel injector which avoids the disadvantages of the prior art.

More particularly, the present invention relates to a fuel injector that is compatible with all gaseous fuel including, but not limited to, compressed natural gas (CNG), compressed from liquefied natural gas (LCNG), propane, and hydrogen, as well as industrial process metering. Furthermore, the invention fulfills definite requirements for durability and accuracy that represents major improvements over current technology.

In keeping with these objects and with others which will become apparent hereinafter, one feature of the present invention resides, briefly stated, in a gaseous fuel injector which has a self-adjusting seat. In the inventive injector there is a self-adjusting component that allows greater tolerances than are usually required for an injector of this type. This improvement results in lower injector costs.

In order to achieve this improvement an injector has a housing; a valve element located in said housing; an armature movable in said housing; and coupling means providing coupling of said armature with said valve element said and being formed as ball-and-socket means allowing continuous alignment of said armature and said valve element relative to one another.

It is another feature of the present invention to provide a self-energizing guiding element. The injector incorporates self-energizing plastic guiding elements which result in inherent resistance to oil contamination, and to eliminate reliance on oil for lubrication.

The injector further has the coupling device which includes a male component and a female component cooperating with one another, said male component being incorporated into a member selected from the group consisting of a valve disc and an actuating component of said valve element.

It is another feature of the present invention that the inventive gaseous fuel injector has a self-cleaning design. The majority of particulate or aerosol contaminants found in injectors come in with the gas, and hence by controlling where pressure drops occur within the injector and by forcing the main pressure drop to occur as the gas exits the injector most of the contaminants are swept through the injector rather than deposited somewhere within the injector. For this purpose, the injector is formed so that the flow path changes its direction in one 90° turn.

The gaseous fuel injector has also a low-noise design. The injector design includes the use of plastics to provide soft stubs at both ends of the armature travel, thus minimizing impact noise.

Finally, the gaseous fuel injector utilizes a zero air gap magnetic circuit. The simplified magnetic circuit eliminates the need to precisely control an air gap during assembly.

The plastic which is used in the inventive injector for the guides and valves is a material selected from the group consisting of polyimide, polyamide-imide, polysulfone, polyphenylene sulfide, polyetheretherketone, polyetherimide, polyetherketone, polyamide, polyarylene sulfide, polyarlyene ketone, polyetherketone ketone, acrylobutyl styrene (ABS), fluorocarbons (such as but not limited to tetrafluoroethylene, fluorinated ethylene propylene and the like), chlorotrifluorethylene and polybenzimidazole.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view schematically showing a gaseous fuel injector in accordance with the present invention;

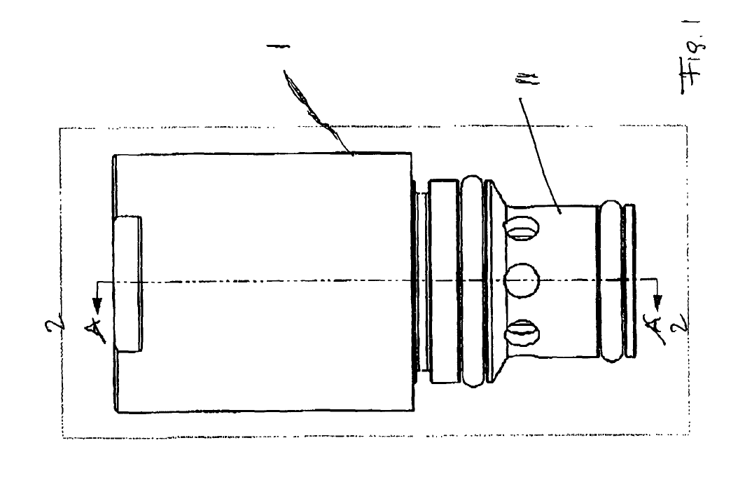

FIG. 2 is a view showing a cross-section of the inventive gaseous fuel injector;

FIG. 3 is a view showing an upper armature guide of the inventive injector; and

FIG. 4 is a view showing a lower guide of the inventive gaseous fuel injector.

### DESCRIPTION OF THE PREFERRED EMBODIMENTS

A gaseous fuel injector in accordance with the present invention has a housing which is identified as a whole with reference numeral 1. It further includes coil 2 with a coil bobbin 3, a movable armature 4, an upper guide 5, a flux ring 6, a spring 7 which spring biases the armature, a valve element or puck 8 with a valve seat 9, O-rings 10, and a valve body 11 which constitutes a part of the housing.

Conventional liquid injectors, as discussed above, benefit from the energy density of liquid fuels; namely, the flow area of the liquid injector is typically very small compared to gaseous injectors. The impact of larger required flow area upon injector seat design for the gaseous injector is significant and unfortunately results in greater manufacturing difficulty of the seat. But to truly understand these issues, it is necessary to review the technology used in gasoline injector seats.

The gasoline injector typically uses metal to metal seats/valve elements. A great deal of effort has been put into the development of reliable and cost effective seat designs. The injector must not leak and must provide years of trouble free operation. The current state of the art is the result of optimizing every aspect of the injector including design, materials, and manufacturing processes. Additionally, gasoline injector manufacturers invest many millions of dollars in custom fuel injector manufacturing equipment necessary to maintain the accuracy and tolerances required for these components. Maintaining excellent surface finishes and extremely small tolerances relating the perpendicularity of the needle and seat have become commonplace within the gasoline manufacturing discipline.

For gaseous applications, it is necessary to design an injector that provides an order of magnitude greater flow area than a gasoline injector. Maintaining perpendicularity between the needle and seat, when the seat is so much larger, is a difficult task. Without perpendicularity between the seat and plunger (equivalent of the needle in a gasoline injector), the injector will have very high leakage rates.

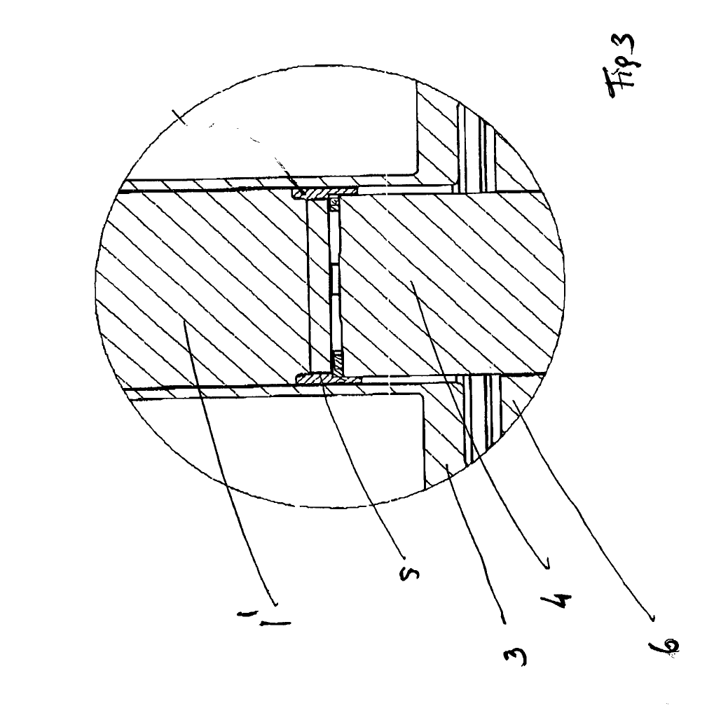

FIG. 3 shows the upper guide 5. It is tubular and has an upper part which is fitted on the pole 1′ and a lower part in which the armature 4 is guided. A radially inwardly extending shoulder or stop can be provided between the upper and lower parts, for stopping the armature.

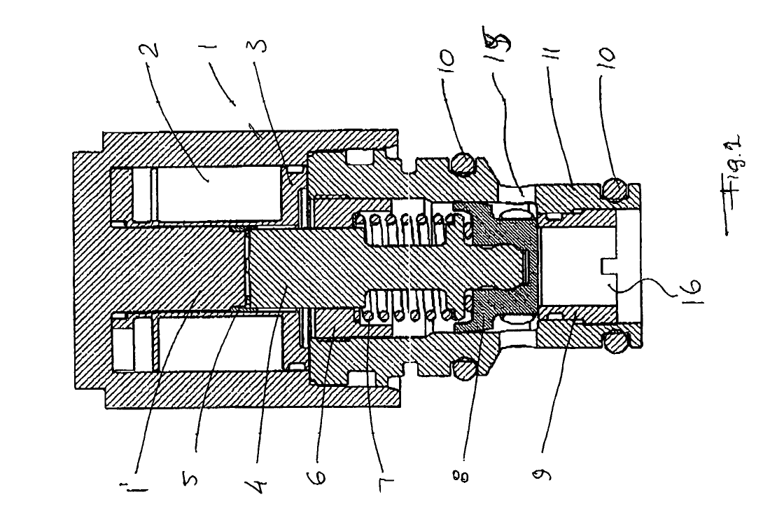

FIG. 2 shows the plunger-shaped armature 4 and the valve 8 of the injector. The improvement is the use of the ball and socket coupling between the armature 4 and the valve 8. The improvement allows the entire valve element to swivel relative to the seat 9 to ensure that perfect alignment is obtained thereby reducing the tolerances required during manufacturing.

The method shown in FIG. 2 is currently the preferred method. This method makes use of a spherical end on the end of the plunger. The elastomer valve element has a port with a spherical receiving cup for the armature. By pressing the two parts together, the valve element snaps into place. The opposite configuration is obvious to those skilled in the art, namely a female spherical port in the armature with a male end on the armature.

The ball-and-socket type coupling between the valve element and the armature, allowing continuous alignment correction to maintain perpendicularity of the mating elements of the valve element to the armature.

The mating elements have sliding surfaces with coefficients of friction such that sliding movement is possible with forces generating during normal injector operation.

The coupling has mating elements consisting of materials with physical properties such that substantially stepless movement is allowed during normal injector operation, i.e. an element in which the coefficient of friction in the static state is substantially similar to that in the sliding or dynamic state.

Also, the coupling can have mating elements consisting of materials with physical properties such that stepped movement is allowed during normal injector operation, i.e. an element in which the coefficient of friction in the static state is significantly higher than that in the sliding or dynamic state.

The armature 4 and the valve element 8 of the inventive injector can consist of mating elements, where the valve is constructed of family of materials including but not limited to: polyimide, polyamide-imide, polysulfone, polyphenylene sulfide, polyetheretherketone, polyetherimide, polyetherketone, polyamide, polyarylene sulfide, polyarlyene ketone, polyetherketone ketone, acrylobutyl styrene (ABS), fluorocarbons (such as but not limited to tetrafluoroethylene, fluorinated ethylene propylene and the like), chlorotrifluorethylene and polybenzimidazole. In the shown embodiment the valve element 8 is composed of plastic.

The coupling device can also have male and female mating components, the male component of which is incorporated into the armature or actuating component of the valve element.

The coupling device can also consist of male and female mating components, the male component of which is incorporated into the valve disc or actuated component of the valve element.

The increasing availability of CNG (compressed natural gas) from LNG (liquefied natural gas) sources has caused problems with many currently available gas injectors due to the loss of lubrication previously found in CNG. The oil content in CNG, primarily residual amounts of compressor oil, is typically found in very small quantities; however, there is enough oil to have a beneficial effect on the older generation of CNG injectors. Even in small quantities, the oil provided adequate lubrication for many injectors, which now, faced with totally dry CNG from LNG, are failing prematurely. The guide used to control the motion of the armature/needle is particularly sensitive to the variability of CNG. With no oil, the more common metal on metal guide fails prematurely, however, with too much oil, viscous damping forces prevent the injector from operating properly.

The injector of the present invention incorporates the guide 5 designed to work ideally under either condition: with no oil, the guide has self lubricating properties that provide extremely high cycle life. If oil is present in small quantities the guide continues to work as if the gas was dry, because it does not require lubrication. If oil is present in large quantities, the guide is designed with a small contact area to minimize viscous damping effects. Typically, the injector continues to operate as designed and flushes the oil through the injector.

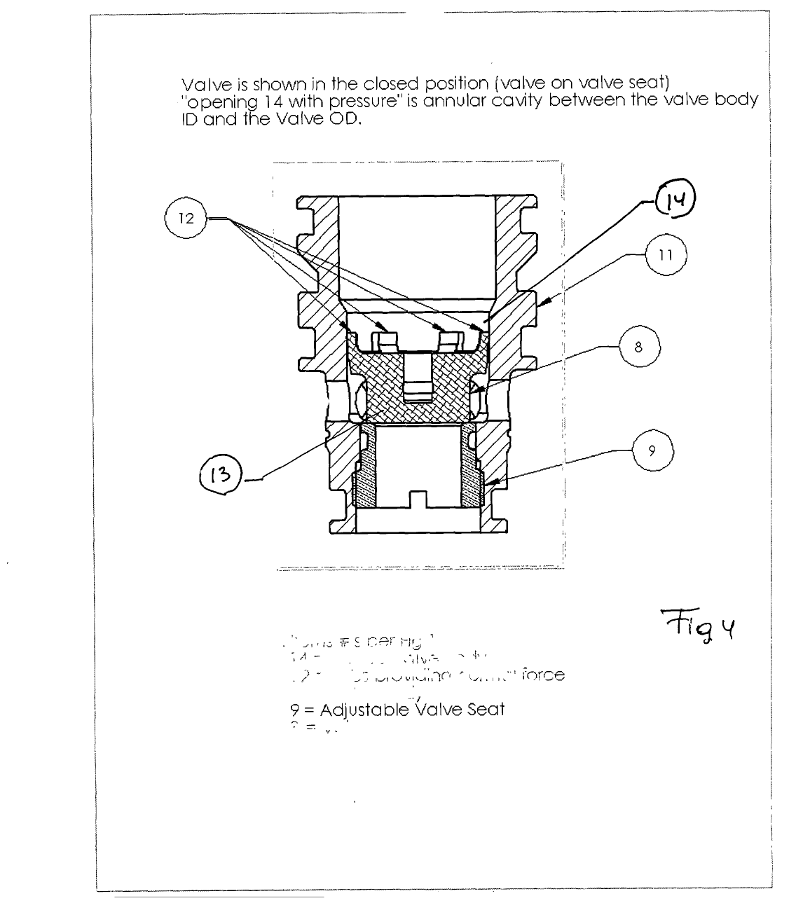

FIG. 4 shows the valve element 8 with its guide formed by guide tabs 12 which extend above the lower part 13 of the valve element 8. The diameter of the tabs is slightly larger than the bore 14 in the valve body 11 which forces the tabs to bend slightly inward engaging the guide. The properties of the plastic materials referred to below allow a new and unique approach to guiding the injector armature.

Some manufacturers turned to dry film lubricants to provide a level of “built-in lubrication”. The embodiment for these improvements took the form of plunger and bore configurations in which the dry film coatings were applied to both the bore and the plunger to provide lubrication. The problem with this approach is that when oil and/or water are ingested by the injector, due to inadvertent use of CNG containing residual compressor oil, the oil enters the guide area due to capillary action and as it begins to work its way into the guide section, viscous damping effects occur. Damping of this type produces strong forces resisting the desired motion of the armature, resulting in greatly retarded motion profiles. As a result, the injector fails to perform the original calibration, many times failing to work at all.

The injector in accordance with the invention uses bearing surfaces which are part of the valve to guide the motion of the armature. The guide 5 and the valve element 8 can be made of a plastic, or dry film lubricants can be used. However, the length of the guide contact surface area must be small when compared to the total length/surface area of the armature. Ideally, for a plunger style armature, the guides will have minimal length when compared to the length of the armature. The embodiment provides the guiding function necessary for consistent response times of the injector and it provides the lubrication necessary for long life. However, it does not result in high level viscous forces when oil is present.

The self energizing guides as described above and depicted in FIGS. 3 and 4 are the preferred embodiment of this improvement; however, the potential of dry film lubricants is also recognized as another embodiment of the disclosure.

The injector has plastic self-energized armature guiding elements. “Plastic” refers to a family of materials including but not limited to: polyimide, polyamide-imide, polysulfone, polyphenylene sulfide, polyetheretherketone, polyetherimide, polyetherketone, polyamide, polyarylene sulfide, polyarlyene ketone, polyetherketone ketone, acrylobutyl styrene (ABS), fluorocarbons (such as but not limited to tetrafluoroethylene, fluorinated ethylene propylene and the like), chlorotrifluorethylene and polybenzimidazole.

The injector incorporates guiding elements which exert a static force normal to the direction of motion on the armature, due to their self-energizing properties.

The guiding elements can be elastomeric, plastic or dry film guiding materials. The guiding elements which, due to their combination of materials and geometric properties, (mechanical design) exert a self-energized force on a guided element.

The injector also has a low contact armature guide design, wherein the length of the guiding element is less than twelve times the length of the armature stroke to minimize viscous damping effects.

The injector further has a self-cleaning design. By far, the majority of particulate and aerosol contaminants found in gaseous injectors are carried into the injector with the gas. Much of this debris exits the gas flow to become lodged within the injector during changes in pressure, or pressure drops, which occur within the injector. Aerosols will condense during pressure changes adding oil and water to any particulate matter that has exited the gas stream just down stream of a major pressure drop.

To minimize these effects, the present invention has been designed so that the major pressure drop occurs across the valve, as the gas is leaving the injector. Any particulate or aerosol contaminants that exit the gas stream will simply exit the injector. This is accomplished by incorporating the simplest flow geometry, resulting in the lowest number of turns required, and hence pressure drop, from the time the gas enters the injector until it exits the injector. Specifically, the side inlet 15 has been provided, while the outlet 16 is provided in the bottom. Thus, the flow turns only once, over 90° turn.

Most injectors have a rather torturous path that the gas must follow to get through the injector. Typically, the gas enters the top of the injector and exits the bottom. This results in numerous turns required within the injector for the gas to follow its flow path. One example uses a bottom feed, side out configuration which is even worse than the top feed configuration.

The injector according to the present invention uses a valve body with a side feed to greatly simplify the flow path. As a result of this simplified flow path, the main pressure drop occurs as the gas is exiting the injector and tends to flush contaminants through the injector. Also, because the highest velocities occur as the gas flow crosses the seat (Mach=1.0), any deposited particles and debris will tend to be dislodged from the seat surfaces, maintaining the critical metering area and shape. Finally, by minimizing change in flow direction, the opportunity for debris deposition and aerosol condensation is reduced.

The present invention combines the two concepts claimed here: 1) a side feed, bottom out injector configuration, and 2) a flow path with minimal direction change. Each of these two features is valid on its own and it is obvious to those skilled in the art that each feature can be used independently or both can be used together. The preferred embodiment additionally incorporates a volume in the injector cavity where debris can accumulate without negatively affecting calibration or injector performance.

The injector also has a low noise design. Liquid fuel injectors do not typically produce excessive noise for two primary reasons; the higher energy density of the fuel allows shorter strokes and hence lower impact energy, and the liquid provides excellent damping of the armature motion. Gaseous injectors have neither of these benefits. The low energy density of the fuel requires both large diameter poppit valves and long stroke actuators. To compound matters, emissions reductions require that the injector respond quickly hence the impulsive loadings within the injector are further increased. These characteristics of the gaseous injector typically result in audible noise levels that are undesirable.

Current generation gas injectors typically use metal seats for durability reasons. Metal stops within the injector result in the highest levels of noise. To minimize the problem, some vendors have adopted the use of low mass valve elements or gas damping effects to minimize the noise generated by the armature or valve needle hitting the stops. Others have adopted the use of rubber like seats but as mentioned before, these suffer from durability issues. These injectors, however, are relatively quiet.

The injector of the present invention has a valve design where the seat is made of hardened stainless steel but the valve element is made of a high quality plastic. The plastic, typically much harder than rubber-like compounds, provides compliance in the valve seat element to minimize noise; however, it also provides durability as good as, or better than, the more traditional steel-to-steel valve element. This improvement reduces noise from the injector when the armature moves from the open to closed position. The other possibility for reduction of noise exists when the injector moves from the closed to open position.

The injector according to the present invention makes use of a zero gap magnetic actuator in which the steel armature 4 contacts the steel pole piece 1′ as the injector moves from the closed to open position. During this motion, no noise reduction is currently used. However, this may be implemented if desired by customers. To minimize the noise generated during this event, the upper guide 5 actually serves a dual purpose, in that it both guides the armature and provides a soft stop for the armature at the end of travel by abutment of the armature against the shoulder between the upper and lower parts of the guide.

The combination of the guide and stop in one component is preferred over two separate components; however, there are cases where different approaches will be required. The most obvious is the use of dry film lubricants instead of an elastomer bearing. For this application the use of a stop ring which serves only one purpose is required.

Future testing may reveal reasons for eliminating the zero air gap armature configuration used in the current injector assembly. If this is the case, the stop will be used for both noise control and to control the air gap between the armature and pole when the injector is energized.

The injector of the present invention has a zero air gap. Port and throttle-body injectors are typically electromagnetically actuated. The actuator consists of the coil assembly, pole piece, and armature. Conventional electromagnetic actuators use ferromagnetic materials, typically electromagnetic irons, for the pole piece and armature of the actuator. Magnetic alloys are desirable because they exhibit high magnetic force when exposed to a magnetic field and they have little or no residual magnetism. However, to obtain optimum magnetic properties, the materials typically require a full anneal after machining which results in very poor mechanical properties, low material hardness being one of the most challenging. As a result of the mechanically soft magnetic alloys, actuators utilizing these materials typically require the use of an air-gap between the armature and pole piece which is controlled with hardened steel stops, in all, a rather complex arrangement. To control the air gap to the required tolerance, the components are precision rounded to ensure that proper tolerances are achieved upon assembly, or components are selectively fit during assembly using some type of a graded spacer, or an adjustment is made during the assembly of the injector to set the air gap. All of these techniques result in higher injector complexity and therefore cost.

The present invention uses common steels for both the armature and pole piece. The materials are through or surface hardened to obtain excellent mechanical and magnetic properties. However, the resulting magnetic circuit exhibits high residual magnetism which if left unchecked, would result in the injector remaining open after the primary magnetizing field has been removed (solenoid de-energized), a phenomenon known as “latching”. To counter the residual magnetism, a modification has been made to the face of the armature which contacts the pole (FIG. 6).

The use of hardened magnetic materials in gaseous fuel injectors has not been seen in any gaseous fuel injectors. Some may be using this technology in diesel or gasoline fuel injectors.

As previously stated, using common steels in a magnetic circuit results in high residual magnetism between the pole and the armature after the solenoid has been de-energized. If residual magnetic forces are high enough, the injector will remain open even with no current flowing through the solenoid, causing undesirable uncontrolled gas flow. The residual magnetism is actually the result of residual flux density, which results in a magnetic force. The magnitude of this force is a function of both the material properties and the geometry of the magnetic circuit. Ideally, to take advantage of the improved mechanical properties of hardened steels, some method must be employed to minimize the magnitude of the residual flux density. This can be achieved by adding air gaps at various points in the magnetic circuit. In the present invention, a small button 16 has been added to the top of the armature, as shown in FIG. 3, to create an air gap over a large percentage of the total surface area that would normally come into contact with the pole. With this design, the residual flux density present in the armature is forced to a low level due to the air gap. The portion of the armature that is in direct contact with the pole is at the higher residual flux density, however, the area is so small that the residual force is insufficient to hold the valve open.

In short, advantage is taken of the improved mechanical properties, namely hardness, to add a feature, a bump stop that would be impossible to do with conventional materials due to the softness of these materials. The net result is an actuator which is relatively easy to manufacture and hence at a lower cost.

This feature can be added in the form of an air gap anywhere in the magnetic circuit, however it has been chosen to add the button to the armature because tolerances are easily controlled and it has the added advantage that if oil should enter the injector, damping forces are minimal with this design. The gap provides a volume for accumulated oil and debris without interfering significantly with injector operation.

It will be understood that each of the elements described above, or two or more together, may also find a useful application in other types of constructions differing from the types described above.

While the invention has been illustrated and described as embodied in a gaseous fuel injector, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. An injector, comprising a housing provided with inlet and outlet means; a valve element located in said housing; an armature movable in said housing; and coupling means providing coupling of said armature with said valve element, said coupling means being formed as ball-and-socket means allowing continuous alignment of said armature and said valve element relative to one another.

2. An injector as defined in claim 1, wherein said coupling means include a mating surfaces of said armature and said valve element, said mating surfaces being formed as sliding surfaces with coefficients of friction allowing a sliding movement with forces generating during an operation of the injector.

3. An injector as defined in claim 1, wherein said coupling means include mating surfaces provided on said armature and said valve element and having a coefficient of friction in a static state which substantially is similar to a coefficient of friction in a dynamic state so as to provide a substantially stepless movement during a normal operation of the injector.

4. An injector as defined in claim 1, wherein said coupling means include mating surfaces provided of said armature and said valve element and composed of materials with a coefficient of friction in a static state which is significantly higher than a coefficient of friction in a dynamic state so as to provide a stepped movement during a normal operation of the injector.

5. An injector, comprising a housing provided with inlet and outlet means; a valve element located in said housing; an armature movable in said housing; coupling means providing coupling of said armature with said valve element; and means for guiding said armature, said guiding means being composed of self-energized plastic.

6. An injector as defined in claim 5, wherein said plastic is a plastic selected from the group consisting of polyimide, polyamide-imide, polysulfone, polyphenylene sulfide, polyetheretherketone, polyetherimide, polyetherketone, polyamide, polyarylene sulfide, polyarlyene ketone, polyetherketone ketone, acrylobutyl styrene, fluorocarbons, chlorotrifluorethylene and polybenzimidazole.

7. An injector as defined in claim 5, wherein said guiding means include a first guide and a second guide spaced from one another in an axial direction of said armature.

8. An injector as defined in claim 7, wherein said first guide is formed by said valve element.

9. An injector as defined in claim 7, wherein said second guide is a tubular guide inserted in an opening of said housing and having a guiding opening in which said armature is guided.

10. An injector as defined in claim 5, wherein said guiding means is formed so that it exerts a static force normal to a direction of motion of said armature.

12. An injector, comprising a housing provided with inlet and outlet means; a valve element located in said housing; an armature movable in said housing; coupling means providing coupling of said armature with said valve element, said inlet and outlet means being formed so that a gas enters the injector through a side and leaves the injector through a bottom.

13. An injector as defined in claim 12, wherein said valve element is formed so that by a relative movement of components a dislodging of foreign matter and debris of a metering orifice is performed.

14. An injector as defined in claim 12, wherein the injector is formed so that the flow path changes its direction by substantially 90°.

15. An injector as defined in claim 1; and further comprising an armature stroke limiting device composed of plastic.

16. An injector as defined in claim 15, wherein said plastic is a material selected from the group consisting of polyimide, polyamide-imide, polysulfone, polyphenylene sulfide, polyetheretherketone, polyetherimide, polyetherketone, polyamide, polyarylene sulfide, polyarlyene ketone, polyetherketone ketone, acrylobutyl styrene, fluorocarbons, chlorotrifluorethylene and polybenzimidazole.

17. An injector as defined in claim 15, wherein said armature limiting device include an armature stop having a substantially smaller geometrical area than a geometrical area of an armature cross-section perpendicular to an axis of movement of said armature.

18. An injector, comprising a housing provided with inlet and outlet means; a valve element located in said housing; an armature movable in said housing; coupling means providing coupling of said armature with said valve element, said housing having a pole piece with which said armature is brought in contact to provide a substantially zero air gap magnetic circuit.
